(19) United States
(12) Patent Application Publication
(10) Pub. No.: US 2015/0328080 A1
(43) Pub. Date: Nov. 19, 2015

(54) Fascial Release Ball

(71) Applicant: Ian Q. Ryan, San Francisco, CA (US)

(72) Inventor: Ian Q. Ryan, San Francisco, CA (US)

(21) Appl. No.: 14/714,220

(22) Filed: May 15, 2015

Related U.S. Application Data
(60) Provisional application No. 61/993,472, filed on May 15, 2014.

(51) Int. Cl. A61H 15/00

(52) U.S. Cl. CPC A61H 15/00; A61H 2015/0064

(57) ABSTRACT

A personal massager comprising a spherical body is secured in a disc shaped housing. The disc shaped housing has a circular cross section, a tapered perimeter, and a crater-like middle portion adapted to receive the spherical body. When the spherical body is secured in the middle portion of the disc shaped housing, a portion of the spherical body is exposed and can freely rotate in any direction. The spherical body is adapted to massage a user's body when a user presses the device against his or her body. The spherical body is further adapted to follow the contours of the body so as to provide versatility to the user when massaging various parts of the body. The device may be mounted on a wall with attachment means such as suction cups to allow a user to use the device in an upright position.

### CROSS-REFERENCE TO RELATED APPLICATIONS

This application claims the benefit of U.S. Provisional Application No. 61/993,472, filed on May 15, 2014, the content of which is incorporated herein by reference in its entirety.

### BACKGROUND

Unattended muscle and joint pains can become chronic problems over time, which can lead to expensive treatments. Although some people receive massage therapies and physical therapies, these treatment options can be expensive and time consuming. Additionally, many conventional massage tools are ineffective and are not versatile. Therefore, there is a need in the prior art for a versatile device that can relieve muscle and joint pains that can be used at the convenience of the user.

Devices are known in the art that claim personal massagers with spherical or wheel-like elements. For example, U.S. Pat. No. 6,315,742 discloses a flat platform with rotating rubber wheels in which the wheel applies pressure to the body. Another device, U.S. Published Patent Application Number 2013/0123676 discloses a plurality of spherical elements disposed on a pair of straps, wherein the spherical elements rotate about a horizontal axis. These devices, however, fail to disclose a disc shaped housing that is adapted to secure a spherical body that freely rotates in any direction to apply pressure to various parts of the body. Additionally, the prior art devices cannot be mounted on an upright surface so as to allow a user to use the device in a standing position.

### BRIEF DESCRIPTION OF THE SEVERAL VIEWS OF THE DRAWINGS

FIG. 1 shows a view of a massage apparatus as used on an upright surface, according to an embodiment.

FIG. 2 shows a view of the massage apparatus as used on the ground, according to an embodiment.

FIG. 3 shows a cross-sectional view of the massage apparatus, according to an embodiment.

FIG. 4 shows a side view of the massage apparatus, according to an embodiment.

FIG. 5 shows a view of the suction cups of the massage apparatus, according to an embodiment.

### DETAILED DESCRIPTION

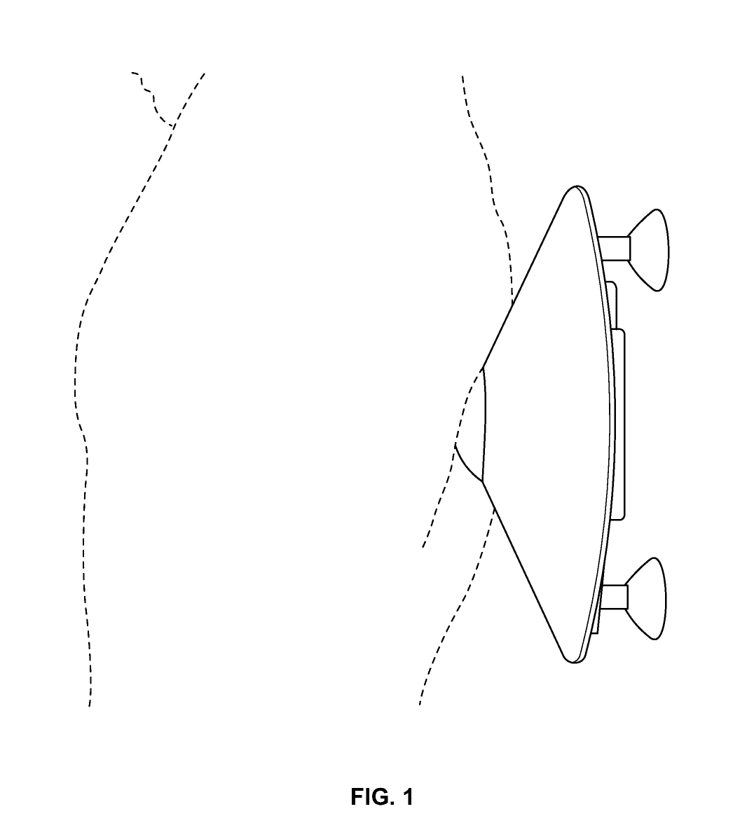

Referring now to FIGS. 1 and 5, there are shown views of the present invention as used against an upright surface, such as a wall. The present invention comprises a disc shaped housing having an upper surface and a lower surface. The upper surface of the housing comprises a spherical body. The lower surface of the housing comprises a plurality of suction cups. The suction cups are adapted to mount the housing in an upright position so that a user may use the device while standing or sitting up. For example, the user may lean against the spherical body to massage his or her back while the device is in an upright position.

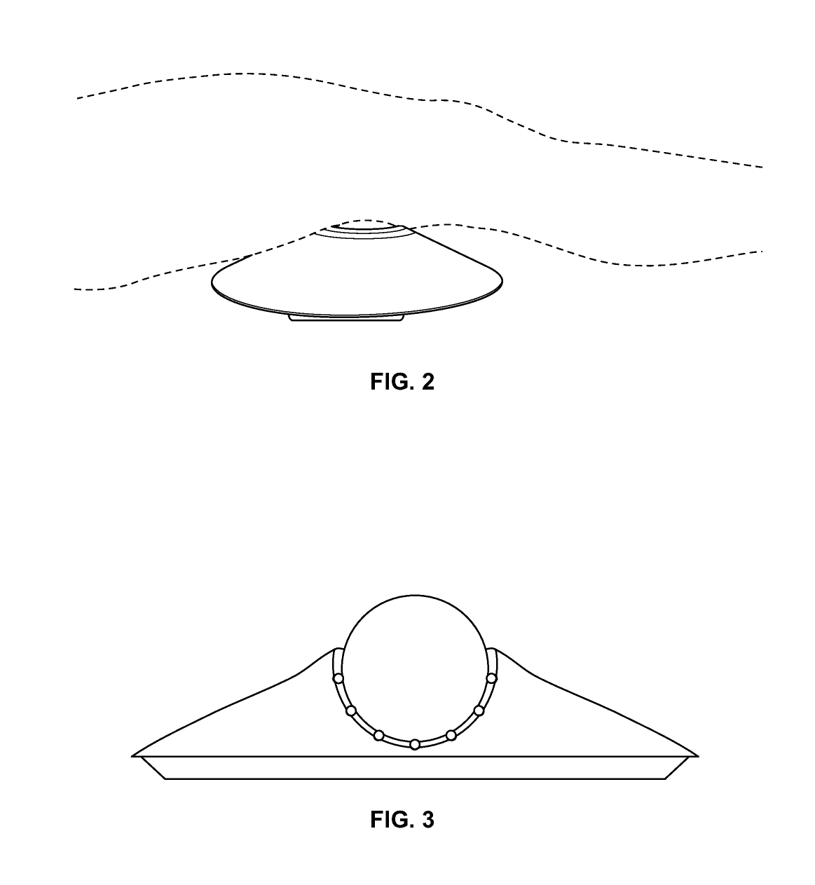

Referring now to FIG. 2, there is shown a view of the present invention as used on the ground. The housing is tapered towards the upper surface so that the diameter of the lower surface is greater than the diameter of the upper surface. In this way, the housing is stable when it is placed on the ground. As disclosed above, the user may lean against the spherical body to relieve tight muscle.

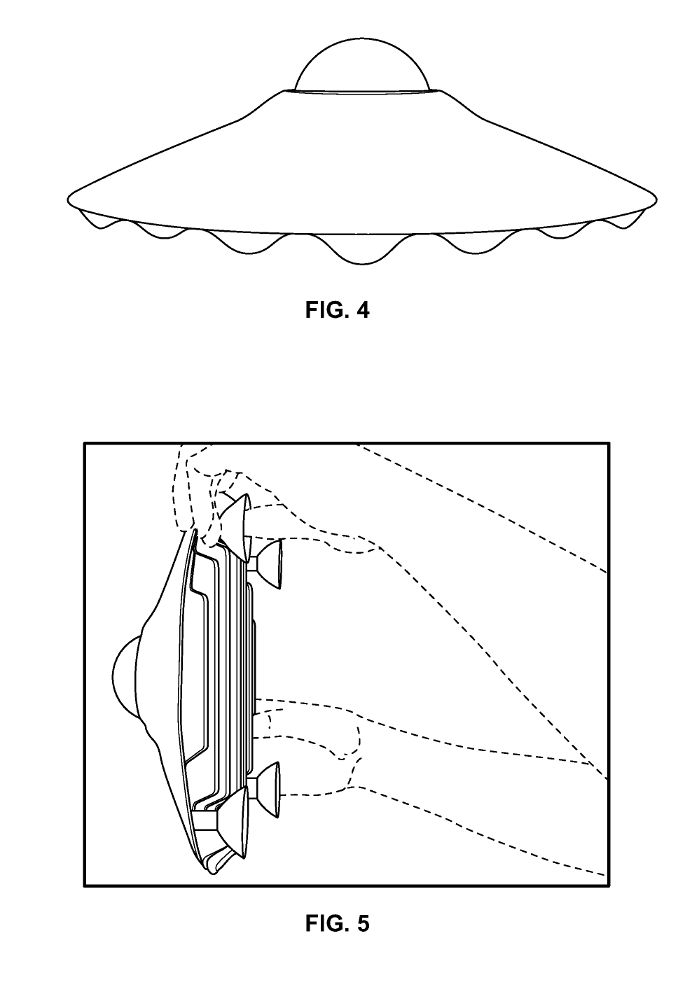

Referring now to FIGS. 3 and 4, there is shown a cross-sectional view and a side view of the present invention, respectively. The present invention comprises a disc shaped housing having a crater-like middle portion that is adapted to hold a spherical body therein. In a preferred embodiment, the housing is composed of silicone, rubber, or plastic. Further, the spherical body is composed of rubber or other suitable material, and can be offered in different densities to accommodate various levels of soreness. A portion of the spherical body is exposed and can freely rotate in any direction via ridges with bearings thereon. In use, the user can lean against or press any portion of his or her body into the spherical body and move in any desired direction to relieve tight muscles.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An apparatus for massaging, comprising:
a frame having a cavity of a half spherical shape;
a roller ball having a spherical shape;
ball bearings located between the frame and the roller ball and allowing the ball to rotate according to external forces; and
suction cups attached to the frame to stabilize the frame from the external forces.
